(19) United States
(12) Patent Application Publication
(10) Pub. No.: US 2009/0206021 A1
(43) Pub. Date: Aug. 20, 2009

(54) Magnetic Filter Adapter

(76) Inventor: Ifor C. Davies, Oakville (CA)

Correspondence Address: GOWAN INTELLECTUAL PROPERTY, 1075 NORTH SERVICE ROAD WEST, SUITE 203, OAKVILLE, ON, L6M-2G2, CA

(21) Appl. No.: 12/371,253

(22) Filed: Feb. 13, 2009

Related U.S. Application Data
(60) Provisional application No. 61/028,655, filed on Feb. 14, 2008.

(51) Int. Cl. B01D 35/30

(52) U.S. Cl. 210/232

(57) ABSTRACT

A magnetic filter adapter is provided and which is adapted for use with a fluid filter having a cylindrical housing which filter includes a closed end, a semi-open end for communicating with a fluid system, and cylindrical filter side walls. The filter adapter has a non-magnetic semi-rigid hollow adaptive housing, including a truncated conical side wall between a housing open end and a housing closed end, having an interior diameter at its closed end which is at least equal to the diameter of the filter closed end diameter, and a gradually increasing interior diameter, and an overall axial height sufficient for extending from the filter closed end towards the filter semi-open end, and spaced away from the side wall surface of the filter, a grasping ring located around the perimeter of the housing open end; a magnet holder located at the housing closed end-field for holding a magnet; and a magnet, held within the adapter by the magnet holder. The adapter is held in operative contact with a filter by magnet attraction from said magnet. The adapter side walls extending radially away from the filter side walls which facilitates removal of the device, after use, so that it can be reused on replacement filters.

### RELATED APPLICATIONS

This application claims the benefit of priority under 35 U.S.C. §119(e) to U.S. Provisional Application Ser. No. 61/028,655 filed on Feb. 14, 2008, the entirety of which is hereby incorporated by reference.

### FIELD OF THE INVENTION

The present invention relates to devices for filtering particulate matter from the fluids and/or lubricants of an engine or other device, and more particularly concerns a holder or adapter which is used to hold such a magnet in place, and thus use magnetic forces to hinder or prevent the movement of magnetically attractive particulate materials through such filtering devices.

### BACKGROUND OF THE INVENTION

Many magnetic filtering devices have been proposed in the prior art for hindering the movement of magnetically attractive particulate matter, such as metal filings or particles, through an engine lubrication system. These devices are usually held within the oil filter, or more commonly, are attached to the external surfaces of the filter. The external devices, can be fitted to the end of the filter or can located around the sides of the filter, and held in place. Exemplary of these devices are the devices described in, for example, U.S. Pat. No. 5,468,381 (Williamson) and/or Canadian Patent Publication No. 2506620 (Lupinacci), published May 2, 2005.

While the known devices may be suitable for a variety of purposes, it will be apparent to those skilled in the art that further improvements in these devices, would be desirable.

In particular, while these and other such devices, have attempted to address the problem of metal particulate matter flowing through an engine lubrication system, they have failed to address the need for such devices to be manufacturable at a cost which would be affordable to the general consuming public. As well, such devices have generally failed to achieve the replaceable-cost efficiencies available to users of the present invention. Further, the prior art devices fail to provide a device which is adaptable to fit a variety of filter sizes, and thus allow for easier selection and stocking of inventory of the devices. Still further, the prior art devices do not facilitate removal of the device, and the oil filter, once the service life of the filter had been reached.

These characteristics of such prior art devices have prevented a more extensive use of such devices.

### SUMMARY OF THE INVENTION

In view of the foregoing disadvantages inherent in the known types of devices now present in the art, the invention disclosed herein provides an improved magnetic filter adapter for use with filters of a fluid lubrication system. The magnetic filter adapter of the present invention includes a structure that allows for easy installation and removal of the adapter from any of a number of different types and sizes of filters while still providing means for magnetically attracting metallic particles from the fluid flow within the filter toward the interior surface of the filter external end wall. At the end of the service life of the filter, the magnetic filter adapter of the present invention can then be easily removed from the filter and re-used with a new filter. As part of the adapter design, a removal ring is located around the perimeter of the adapter. This removal ring facilitates removal of the magnetic filter adapter; even in confined areas of an engine.

Further, the magnetic filter adapter of the present invention at least partially protects the sides and end of the filter, and thus, when removed from the filter, provides the mechanic easy access to an essentially clean filter end surface, and thus further facilitates removal of the filter from the engine.

Upon a closer review of the more detailed description herein, those skilled in the art will recognize that the concepts of the present invention easily overcome the problems described above which have been heretofore commonly associated with magnetic filter adapter devices. As such, the general purpose of the present invention is to provide a new and improved magnetic filter adapter which has all the advantages of the prior art and none of the disadvantages.

It is an additional object of the present invention to provide a new and improved magnetic filter adapter which enhances the filtering process of lubricating and cooling fluids by removing a significant amount of magnetically attractable particulate matter from said fluids as they engage said filtering process.

It is a further object of the present invention to provide a new and improved magnetic filter adapter which is effective in removing metal particles from lubricating fluids before said fluids reach the mechanical filtering elements of the filtering system, thereby leaving said filtering elements free to trap nonmetallic particles.

It is a further object of the present invention to provide a new and improved magnetic filter adapter which reduces the amount of debris and particulate matter reaching the mechanical filtering elements of the filtering system, thereby prolonging the life of said filtering elements.

It is a further object of the present invention to provide a new and improved magnetic filter adapter which may be manufactured for use with a wide variety of fluid filtering systems.

It is a further object of the present invention to provide a new and improved magnetic filter adapter which is reusable.

It is a further object of the present invention to provide a new and improved magnetic filter adapter which is quickly and easily installed on a filtering system without the need for special tools or skills.

It is a further object of the present invention to provide a new and improved magnetic filter adapter which may be easily cleaned and which also keeps the end and at least a portion of the sides of the filter, clean.

It is another object of the present invention to provide a new and improved magnetic filter adapter which may be easily and efficiently manufactured, marketed, stocked, and installed.

It is still a further object of the present invention to provide a new and improved magnetic filter adapter which is of durable and reliable construction.

An even further object of the present invention is to provide a new and improved magnetic filter adapter which is susceptible of a low cost of manufacture with regard to both materials and labor, and which accordingly is then susceptible of low prices of sale to the consuming public, thereby making such a magnetic filter adapter economically available to the buying public.

These together with other objects of the invention, along with the various features of novelty which characterize the magnetic filter adapter of the present invention, are at least partially, or fully provided by the magnetic filter adapter, described and claimed in the present application. It is to be noted, though, that the more important objects of the present invention have been outlined rather broadly in order that the detailed description thereof which follows may be better understood, and in order that the present contribution to the art may be better appreciated. For a better understanding of the invention, its operational advantages and the specific objects attained by its uses, reference should be made to the accompanying drawings and descriptive matter in which there is illustrated a preferred embodiment of the invention.

Those skilled in the art will readily ascertain, however, that the invention is capable of other embodiments and of being practised and carried out in various ways. In this respect, the details of construction disclosed herein, and the arrangements of the components set forth in the following description and appended drawings are for illustrative purposes, only, and are not intended to be limiting in scope. Those skilled in the art will appreciate, as well, that the conception upon which this disclosure is based, may be readily utilized as a basis for the designing of other structures, methods and systems for carrying out the several purposes of the present invention. The other structures may include, but are not limited to, those which are aesthetic in nature, or those which include the substitution of other materials as they become available, and which substantially perform the same function in substantially the same manner with substantially the same result as the present invention. It is important, therefore, that the claims appended hereto be regarded as including such equivalent structures, constructions, methods and systems insofar as these do not depart from the spirit and scope of the present invention.

Accordingly, it is a principal advantage of the present invention to provide a magnetic filter adapter for use with a fluid filter having a cylindrical housing which filter includes a closed end, a semi-open end for communicating with a fluid system, and cylindrical filter side walls, the filter adapter comprising:

a non-magnetic, semi-rigid and hollow housing having a truncated conical side wall structure between a housing open end and a housing closed end, having an interior diameter at its closed end which preferably is at least equal to or greater than the diameter of the filter closed end diameter, and a gradually increasing interior diameter; and an overall axial height sufficient for extending from the filter closed end towards the filter semi-open end, so that said wall structure is increasingly spaced away from the side wall surface of the filter;

a preferably reinforced grasping ring located around the perimeter of the housing open end;

a magnet holder located at the housing closed end-field for holding a magnet; and

a magnet, and preferably, a flat, annular shaped magnet, held within the adapter by the magnet holder;

wherein the magnetic filter adapter is held in operative contact with a filter by magnet attraction between the magnet and the filter, and wherein the housing side walls extend radially away from the filter side walls.

In a further aspect, the present invention provides a magnetic filter adapter of the type hereinabove described, additionally comprising a planar metal liner fitted so as to lie within, and essentially across, the closed end of the non-magnetic housing, and having an attachment device or means, to attach the metal liner to the closed end of the non-magnetic housing. The attachment device can be, for example, glue, screws, rivets, bolts, or a resilience plastic tabs, or the like, or combinations thereof. Preferably, however, a single rivet in the centre of the metal liner is most preferred. The liner can be magnetic or non-magnetic, but is preferably rigid. A steel or aluminum disk would be suitable in this application.

The magnet is preferably glued, or otherwise fastened, to the liner, and thus is held in place at the closed end of the housing.

### DETAILED DESCRIPTION OF THE INVENTION

In the present application, the term “filter” refers primarily to an oil filter. However, the skilled artisan will be aware that any cylindrical shaped filter having a magnetically attractive end surface can be used. This can include, for example, fuel filters, diesel fuel filters, hydraulic filters, transmission or differential fluid filters, or other filters which might be used in automotive, truck, bus, train, boat or other marine engines, or any other equipment requiring the filtering of fluids, wherein magnetic particulate matter might be present or produced. Accordingly, while the present application will be hereinafter described with particular reference to its use in combination with an oil filter, the skilled artisan would be aware that the present application is equally applicable in other applications.

Also, unless otherwise specifically noted, all of the features described herein may be combined with any of the above aspects, in any combination.

### BRIEF DESCRIPTION OF THE DRAWINGS

Embodiments of this invention will now be described by way of example only in association with the accompanying drawings in which:

FIG. 1 is a bottom perspective view of a currently preferred magnetic filter adapter, which is exemplary of the present invention;

FIG. 2 a top perspective view of the device shown in FIG. 1;

FIG. 3, is a perspective view of a annular magnet used in the adapter of FIG. 1 and fitted within a magnet liner; and

FIG. 4 is a cross-sectional side view of the adapter of FIG. 1 in place over a conventional oil filter.

### DETAILED DESCRIPTION OF THE PREFERRED EMBODIMENTS

The novel features which are believed to be characteristic of the present invention, as to its structure, organization, use and method of operation, together with further objectives and advantages thereof, will be better understood from the following drawings in which a presently preferred embodiment of the invention will now be illustrated by way of example only. In the drawings, like reference numerals depict like elements.

It is expressly understood, however, that the drawings are for the purpose of illustration and description only and are not intended as a definition of the limits of the invention.

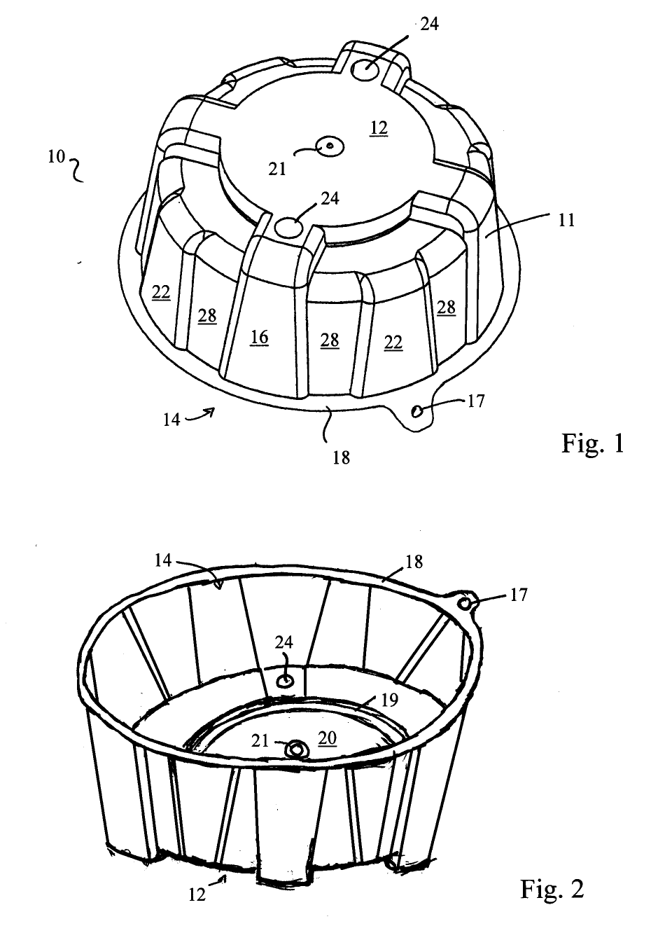

Referring to FIG. 1, a magnetic filter adapter 10 consisting of a non-magnetic housing 11 is shown having a closed end 12, an open end 14, and a side wall 16. Side wall 16 has a truncated conical shape. The interior diameter of housing 11 increases as one moves axially from closed end 12 towards open end 14. At open end 14, a rim (or ridge) 18 is provided which extends radially outward from the edge of open end 14. An optional safety “tie-back” attachment hole 17 is provided on rim 18.

At closed end 12, housing 11 has a series of detents 22 and indents 28. These detents and indents provide structural rigidity to housing 11, and act as finger holes for removal or placement of adapter 10. As such, while not required, detents 22 and indents 28 are preferably used.

It is also to be noted that indents 28 may be positioned so as to assist in holding magnet 20 in place using the flexible resilience of housing I1. In a preferred embodiment, however, magnet 20 has been glued, using for example, an epoxy glue, to a planar metal cup or liner 19, so as to be held securely within housing 11. Liner 19, which can be magnetic or non-magnetic, has been riveted into place using a single rivet 21, which passes through the centre of closed end 12, and approximately the middle of liner 19.

Liner 19 is preferably a thin, planar nickel plated steel disk or plate having an upturned edge so as to form a cup around magnet 20. Liner 19 has a diameter similar to the diameter of the oil filter, and has a thickness of between 0.2 and 3 cm, and more preferably, between 0.5 and 1.5 cm.

Housing 11 is preferably made of a resilient plastic material which preferably has been selected so as to be suitable for use within an engine environment. For most applications, a heat resistant polyethylene product can be used. Preferably, a recycled plastic material is used for production of the housing. However, any suitable material might be used. Further, the plastic housing can be colour coded to denote different filter sizes, or alternatively, the housings can be made of plastics of any selected colour.

Drain holes 24, as will be described hereinbelow, are provided on closed end 12.

Magnet 20 is best seen in FIGS. 2 to 4, and is preferably a flat annular ring which lays flat within liner 19. Magnet 20 can be any suitable magnet including, for example, a flat ceramic magnet with a central axial aperture therethrough. Those skilled in the art will recognize however, that a permanent magnet, or even an electromagnet may just as readily be used, said electromagnet having an inner conductive core which is electrically connected to an external power source, such as an engine battery (not shown), via means which are well known. Magnet 20 may be formed of a wide variety of ferromagnetic materials, including ceramic magnetic material such as ferrite and barium or strontium alloys, rare-earth materials from the rare-earth cobalt and the rare-earth transition metal group, an aluminum-nickel alloy and various iron-chromium-cobalt alloys, all of which are well known. Magnet 20 is preferably a radius type magnet to increase the magnetic field at the contact area.

In contrast to the approaches taken by some prior art devices, it is preferred in the practice of the present invention, that the magnet provide only sufficient “pull” to hold the adapter in place during operation of the vehicle, or the like. As such, while devices are known that claim magnetic “pulls” in excess of 75 pounds, it is a preferred feature of the present invention, that a lower strength magnet be utilized in the present invention. Preferably, the pull of the magnet 20 is less than 20 pounds, and more preferably between 2 and 15 pounds, and still more preferably between 4 and 12 pounds. A most preferred magnet therefore, is a low cost, Ceramic 5 magnet having a pull of between 4 to 12 pounds.

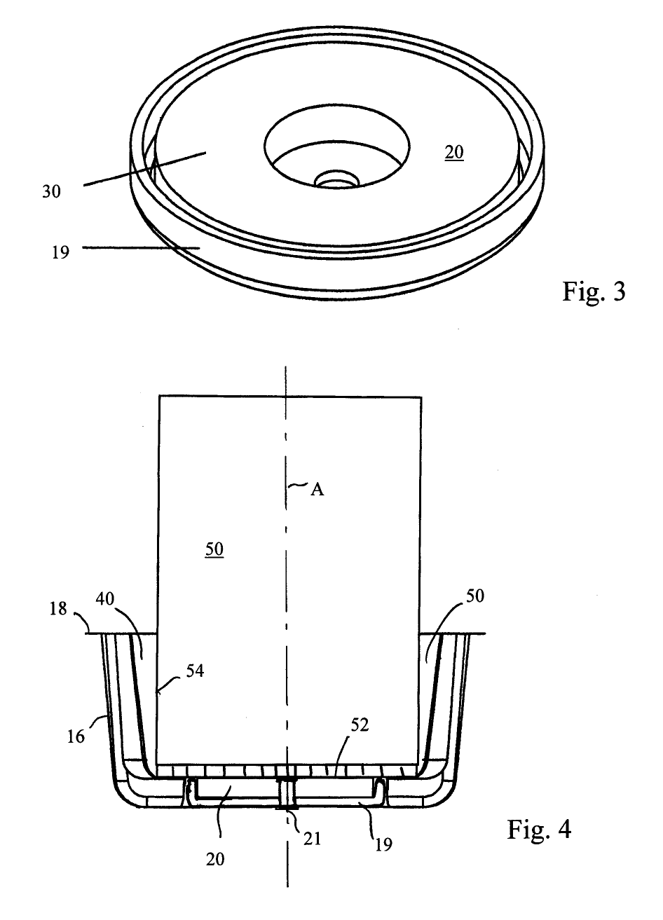

Magnet 20 preferably has a diameter so that it is adapted to be fitted within liner 19, as seen in FIG. 3. An optional cover (not shown) may be placed over the inner exposed surface 30 of magnet 20, or surface 30 can be left open and exposed so as to better contact the end wall 52 of a conventional oil filter 50, as seen in FIG. 4.

In FIG. 4, a cut-away view of the adapter of FIG. 1 is shown in place on an oil filter 50. Magnet 20 is clearly in contact with the end of filter 50. However, as shown, the remainder of adapter 10 preferably has little, if any, contact with the remainder of oil filter 50. Instead, oil filter 50 is intended to loosely fit within the open end 14 of adapter 10, and be held in place simply by the attractive force of magnet 20. As such, side walls 16 are angled so as to be away from the cylindrical outer side wall 54 of oil filter 50. As a result, adapter 10 can be attached to a variety of different filters having different diameters. As long as filter 50 fits within adapter 10 so as to contact magnet 20, then adapter 10 can be used.

As such, the user typically only needs to keep in inventory, one or two sizes of adapter 10, which can be used over a wide variety of filters. For example, two different sized adapters having a closed end diameter of 3.5 inches (9 cm) or 5.5 inches (14 cm) will cover most filters in common use. The smaller diameter adapter is typically used for cars, while the larger adapter is primarily used for truck application.

The open end diameter for these two adapters would be roughly 4 and 6 inches, respectively.

The axial height of adapter 10 is typically 1 to 3 inches, and more preferably, between 1.5 and 2.5 inches. As such, in use, adapter 10 will at least partially extend along the cylindrical outer wall 54 of filter 50. As such, it protects at least the closed end 52 from dust, dirt, grime etc. which might otherwise be found in the engine compartment, or the like.

However, since a gap 40 is present between walls 16 and filter wall 52, some water can collect in adapter 10 and/or some condensation of water can also form in this area. Accordingly, drain holes 24 are provided to allow such water to escape.

It is to be noted that adapter 10 can be used in either a vertical fashion (as shown in FIG. 4), or in a horizontal fashion.

Rim 18 is preferably an essentially rigid, but resilient, ridge that can be used to grasp when removing the adapter 10 from filter 50. By grasping rim 18, adapter 10 can be removed simply by pulling it along the axial direction of the filter 50 (which is typically co-axial to the axial direction of adapter 10, and indicated by “A”). Since the “pull” of the magnet is only sufficient to hold adapter 10 in place during use, the pull of the magnet can be easily overcome.

More importantly, since the adapter is intended to permit easy removal of the adapter by pulling the adapter in the axial direction, which is the same direction the oil filter 50 is intended to be removed from the engine, the engine compartment will typically be designed so as to provide clearance in this direction. As such, removal of adapter 10 is facilitated.

In contrast, this feature may not always be the case in prior art devices that require a sideways movement in order to release a stronger magnet from the filter. Also, removal of adapter 10 can be easily accomplished prior to removal of filter 50 so as to expose an virtually clean end of filter 50. This facilitates removal of filter 50 from the engine (not shown) since a clean surface will be provided on the end and lower surfaces of filter 50 to which a mechanic can grasp, or to which, a removal tool can be attached.

In contrast, prior art adapters that are fitted to the filter can be difficult to remove from the filter while the filter is still in place on the engine, and as such, the user is required to remove the entire assembly (filter and magnetic attachment) as one unit. As such, the user must still deal with a filter/adapter surface which is covered with road grime. This accumulated road grime can therefore hinder removal of the filter from the engine;—particularly when it is desired to re-use the adapter for subsequent filters, and thus, the user must try to avoid causing any damage to the adapter.

Thus, it is apparent that there has been provided, in accordance with the present invention, a magnetic filter adapter which fully satisfies the goals, objects, and advantages set forth hereinbefore. Therefore, having described specific embodiments of the present invention, it will be understood that alternatives, modifications and variations thereof may be suggested to those skilled in the art, and that it is intended that the present specification embrace all such alternatives, modifications and variations as fall within the scope of the appended claims.

Additionally, for clarity and unless otherwise stated, the word “comprise” and variations of the word such as “comprising” and “comprises”, when used in the description and claims of the present specification, is not intended to exclude other additives, components, integers or steps.

Moreover, the words “substantially” or “essentially”, when used with an adjective or adverb is intended to enhance the scope of the particular characteristic; e.g., substantially planar is intended to mean planar, nearly planar and/or exhibiting characteristics associated with a planar element.

Further, use of the terms “he”, “him”, or “his”, is not intended to be specifically directed to persons of the masculine gender, and could easily be read as “she”, “her”, or “hers”, respectively.

Also, while this discussion has addressed prior art known to the inventor, it is not an admission that all art discussed is citable against the present application.

We claim:

1. A magnetic filter adapter for use with a fluid filter having a cylindrical housing which filter includes a closed end, a semi-open end for communicating with a fluid system, and cylindrical filter side walls, the filter adapter comprising:
a non-magnetic, semi-rigid and hollow housing having a truncated conical side wall structure between a housing open end and a housing closed end, having an interior diameter at its closed end which is at least equal to or greater than the diameter of the filter closed end diameter, and a gradually increasing interior diameter; and an overall axial height sufficient for extending from the filter closed end towards the filter semi-open end, so that said wall structure is increasingly spaced away from the side wall surface of the filter;
a grasping ring located around the perimeter of the housing open end;
a magnet holder located at the housing closed end-field for holding a magnet; and
a magnet held within the adapter by the magnet holder;
wherein the magnetic filter adapter is held in operative contact with a filter by magnet attraction between the magnet and the filter, and wherein the housing side walls extend radially away from the filter side walls.

2. A magnetic filter adapter as claimed in claim 1 additionally comprising a series of detents and indents on said truncated conical side wall structure.

3. A magetic filter adapter as claimed in claim 1 additionally comprising a planar liner fitted so as to lie within the closed end of the non-magnetic housing, and having an attachment device to attach the metal liner to the closed end of the non-magnetic housing, and to which liner, said magnet can be attached.

4. A magnetic filter adapter as claimed in claim 3 wherein said liner and said magnet are held in said adapter using a single rivet.

5. A magnetic filter adapter as claimed in claim 3 wherein said liner is a planar disk or plate having an upturned edge so as to form a cup around said magnet.

6. A magnetic filter adapter as claimed in claim 1 additionally comprising at least one drain hole to allow collected water to drain from said housing.

7. A magnetic filter adapter as claimed in claim 1 wherein said magnet is a flat, annular shaped magnet.

8. A magnetic filter adapter as claimed in claim 1 wherein said magnet has a pull of less than 20 pounds.

9. A magnetic filter adapter as claimed in claim 1 wherein said magnet is a ceramic magnet having a pull of between 4 to 12 pounds.
